(19) United States
(12) Patent Application Publication
(10) Pub. No.: US 2026/0175931 A1
(43) Pub. Date: Jun. 25, 2026

(54) Dual-track all-terrain vehicle

(71) Applicant: LUCKYRAM TECHNOLOGY CO.,LTD, Guangzhou (CN)

(72) Inventors: Qiyao XIE, Guangzhou (CN); Jichun ZHAN, Guangzhou (CN)

(73) Assignee: LUCKYRAM TECHNOLOGY CO.,LTD, Guangzhou (CN)

(21) Appl. No.: 19/037,310

(22) Filed: Jan. 27, 2025

(30) Foreign Application Priority Data
Dec. 23, 2024 (CN) 202423171418.7

(51) Int. Cl. B62D 55/065; B62D 11/00; B62D 55/10; B62D 55/104

(52) U.S. Cl. CPC B62D 55/065; B62D 11/003; B62D 55/10; B62D 55/104

(57) ABSTRACT

A dual-track all-terrain vehicle includes a vehicle body, where two sides of the vehicle body each are provided with a mounting seat; a guide wheel mechanism, a first Christie suspension mechanism, a second Christie suspension mechanism, and a driving wheel mechanism are hinged on the mounting seat; the mounting seat is further provided with a track tensioner and a motor; the guide wheel mechanism, the first Christie suspension mechanism, the second Christie suspension mechanism, the driving wheel mechanism, and the track tensioner located at a same side of the vehicle body are provided with a track; a power output shaft of the motor is connected to the driving wheel mechanism through a belt transmission pair in a transmission manner; and the vehicle body is provided with a vehicle control unit and two motor drivers.

### CROSS-REFERENCE TO THE RELATED APPLICATIONS

This application is based upon and claims priority to Chinese Patent Application No. 202423171418.7, filed on Dec. 23, 2024, the entire contents of which are incorporated herein by reference.

### TECHNICAL FIELD

The present disclosure relates to the technical field of all-terrain vehicles, and in particular to a dual-track all-terrain vehicle.

### BACKGROUND

All-terrain vehicles are vehicles that can travel on any terrain and can move freely on terrains that are difficult for ordinary vehicles to maneuver. All-terrain vehicles are becoming increasingly popular as they have multiple purposes and are not restricted to road conditions.

However, all-terrain vehicles face various road conditions and encounter the following problems when they run on rough and bumpy roads. Due to high resistance of roads effecting the steering of the vehicles, the accuracy and stability of a driver's steering of the all-terrain vehicle are poor. In addition, the uneven loads on the track wheel system cause significant wear, and all-terrain vehicles are prone to roll and overturn due to poor lateral stability.

### SUMMARY

In order to solve the above-mentioned problems existing in the prior art, an objective of the present disclosure is to provide a dual-track all-terrain vehicle.

To achieve the above technical objective and technical effect, the present disclosure is implemented through the following technical solution.

A dual-track all-terrain vehicle includes a vehicle body, where two sides of the vehicle body each are provided with a zigzag mounting seat; a guide wheel mechanism, a first Christie suspension mechanism, a second Christie suspension mechanism, and a driving wheel mechanism are hinged on the mounting seat; dampers are arranged between the mounting seat and each of the guide wheel mechanism, the first Christie suspension mechanism, and the second Christie suspension mechanism; a damper is provided between the driving wheel mechanism and the vehicle body; the mounting seat is further provided with a track tensioner and a motor; the guide wheel mechanism, the first Christie suspension mechanism, the second Christie suspension mechanism, the driving wheel mechanism, and the track tensioner located at a same side of the vehicle body are provided with a track; a power output shaft of the motor is connected to the driving wheel mechanism through a belt transmission pair in a transmission manner; the vehicle body is provided with a vehicle control unit and two motor drivers; a front part of the vehicle body is provided with a linear steering control mechanism; a signal output terminal of the linear steering control mechanism is connected to a signal input terminal of the vehicle control unit through a cable; a signal output terminal of the vehicle control unit is connected to signal receiving terminals of the two motor drivers through a cable; and the two motor drivers are respectively connected to wiring terminals of the two motors through a cable.

In the dual-track all-terrain vehicle, the linear steering control mechanism includes a freely rotatable steering shaft, a reaction force assembly for resetting the steering shaft, and a linear sensor for monitoring a rotation angle of the steering shaft; the steering shaft, the reaction force assembly, and the linear sensor are located at the front part of the vehicle body; the reaction force assembly includes a rectangular mounting plate, two clamping elements, a guide shaft, a rack, and two compression springs; the two clamping elements are respectively provided on front surfaces at two ends of the mounting plate; two ends of the guide shaft are respectively clamped between the two clamping elements and the mounting plate; the guide shaft is sleeved with the rack and the two compression springs; the two compression springs are respectively clamped between the rack and the two clamping elements; a bottom part of the steering shaft is provided with a transmission gear and a first synchronous transmission wheel; the transmission gear meshes with the rack; a sensing shaft of the linear sensor is provided with a second synchronous transmission wheel; and the first synchronous transmission wheel is in rolling contact with the second synchronous transmission wheel.

In the dual-track all-terrain vehicle, the linear sensor is an angular displacement sensor.

In the dual-track all-terrain vehicle, a top part of the steering shaft is provided with a handlebar for controlling the rotation of the steering shaft.

In the dual-track all-terrain vehicle, the guide wheel mechanism includes a linear guide wheel swing arm, a linear guide wheel mounting arm, and four guide wheels; a rear part of the guide wheel swing arm is hinged on a front part of the mounting seat; a damper is provided between a top part of the guide wheel swing arm and the mounting seat; the guide wheel mounting arm is fixed on a front part of the guide wheel swing arm; and two ends of the guide wheel mounting arm each are provided with two guide wheels.

In the dual-track all-terrain vehicle, the first Christie suspension mechanism includes a linear first road wheel swing arm, a “\hat{ }”-shaped first road wheel mounting arm, and three first road wheels; an upper part of the first road wheel swing arm is hinged on the mounting seat; a damper is provided between a middle part of the first road wheel swing arm and the mounting seat; the first road wheel mounting arm is fixedly provided at a bottom part of the first road wheel swing arm; and a front part of the first road wheel mounting arm is provided with one first road wheel, while a rear part of the first road wheel mounting arm is provided with two first road wheels that are coaxially arranged.

In the dual-track all-terrain vehicle, the second Christie suspension mechanism includes a “<”-shaped second road wheel swing arm, a “\hat{ }”-shaped second road wheel mounting arm, and three second road wheels; a middle part of the second road wheel swing arm is hinged on the mounting seat; a damper is provided between a top part of the second road wheel swing arm and the mounting seat; the second road wheel mounting arm is fixedly provided at a bottom part of the second road wheel swing arm; and a front part of the second road wheel mounting arm is provided with one second road wheel, while a rear part of the second road wheel mounting arm is provided with two second road wheels that are coaxially arranged.

In the dual-track all-terrain vehicle, the driving wheel mechanism includes a linear driving wheel mounting arm and a driving wheel; a front part of the driving wheel mounting arm is hinged on a rear part of the mounting seat; the driving wheel is rotatably provided at a rear part of the driving wheel mounting arm; the belt transmission pair includes a driving pulley, a transmission belt, and a driven pulley; the driving pulley is provided on the power output shaft of the motor; the driven pulley is provided on the driving wheel; and the transmission belt is tensioned by the driving pulley and the driven pulley.

The present disclosure has the following beneficial effects. The linear steering control mechanism is used to acquire the rotation angle of the steering shaft rotated by the driver and generate steering signals for the vehicle control unit. The vehicle control unit sends operation signals of the two motor drivers respectively, and the two motor drivers respectively drive the two motors to operate. In this way, the tracks at the two sides of the vehicle body are driven to perform differential operation, achieving the steering of the dual-track all-terrain vehicle. The linear sensor can accurately monitor the rotation angle of the steering shaft rotated by the driver, improving the steering control accuracy of the dual-track all-terrain vehicle. The driver operates the steering shaft to rotate, without being affected by changes in the resistance subjected by the track wheels, improving the steering stability of the dual-track all-terrain vehicle and facilitating the driver's operation. The first Christie suspension mechanism with three first road wheels cooperates with the second Christie suspension mechanism with three second road wheels to effectively share the weight of the all-terrain vehicle, such that each road wheel can evenly bear the load. The design reduces the wear of the road wheels, and improves the lateral stability of the all-terrain vehicle, thereby preventing the all-terrain vehicle from rolling or overturning during running.

### BRIEF DESCRIPTION OF THE DRAWINGS

The drawings described herein are provided for further understanding of the present disclosure, and constitute a part of the present disclosure. The exemplary embodiments of the present disclosure and illustrations thereof are intended to explain the utility model, rather than to constitute inappropriate limitations to the present disclosure. Figures:

FIG. 1 is a partial three-dimensional structural diagram of a dual-track all-terrain vehicle according to the present disclosure;

FIG. 2 is a structural diagram of a mounting seat, a guide wheel mechanism, a first Christie suspension mechanism, a second Christie suspension mechanism, a driving wheel mechanism, dampers, a track tensioner, a belt transmission pair, and a track assembly located at one side of a vehicle body according to the present disclosure;

FIG. 3 is a partial structural diagram of a linear steering control mechanism according to Embodiment 1 of the present disclosure;

FIG. 4 is a schematic diagram of a trajectory of the dual-track all-terrain vehicle turning right according to the present disclosure; and

FIG. 5 is a relationship coordinate diagram between a rotation angle of a steering shaft and a turning radius of the dual-track all-terrain vehicle according to the present disclosure.

Reference Numerals: 1. vehicle body; 2. mounting seat; 3. guide wheel mechanism; 301. guide wheel swing arm; 302. guide wheel mounting arm; 303. guide wheel; 4. first Christie suspension mechanism; 401. first road wheel swing arm; 402. first road wheel mounting arm; 403. first road wheel; 5. second Christie suspension mechanism; 501. second road wheel swing arm; 502. second road wheel mounting arm; 503. second road wheel; 6. driving wheel mechanism; 601. driving wheel mounting arm; 602. driving wheel; 7. damper; 8. track tensioner; 9. motor; 10. track; 11. belt transmission pair; 1101. driving pulley: 1102. transmission belt; 1103. driven pulley; 12. linear steering control mechanism; 1201. steering shaft; 1201a. handlebar; 1202. reaction force assembly; 1203. linear sensor; 1202a. mounting plate; 1202b. clamping element; 1202c. guide shaft; 1202d. rack; 1202e. compression spring; 1204. transmission gear; 1205. first synchronous transmission wheel; and 1206. second synchronous transmission wheel.

### DETAILED DESCRIPTION OF THE EMBODIMENTS

The present disclosure is described in detail below with reference to the drawings and embodiments.

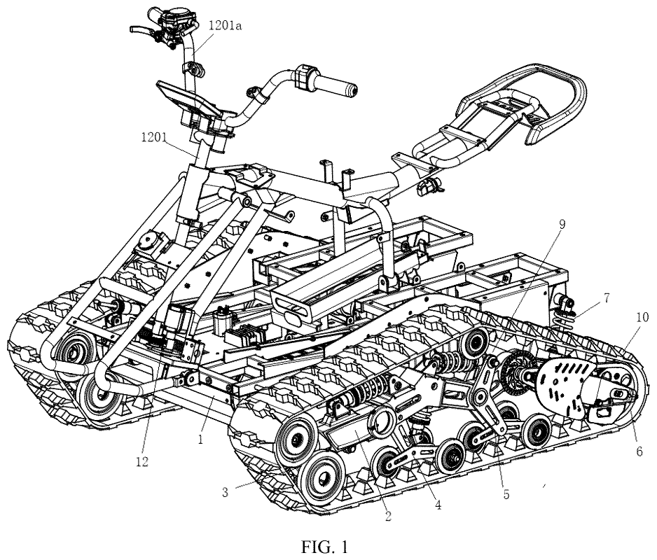

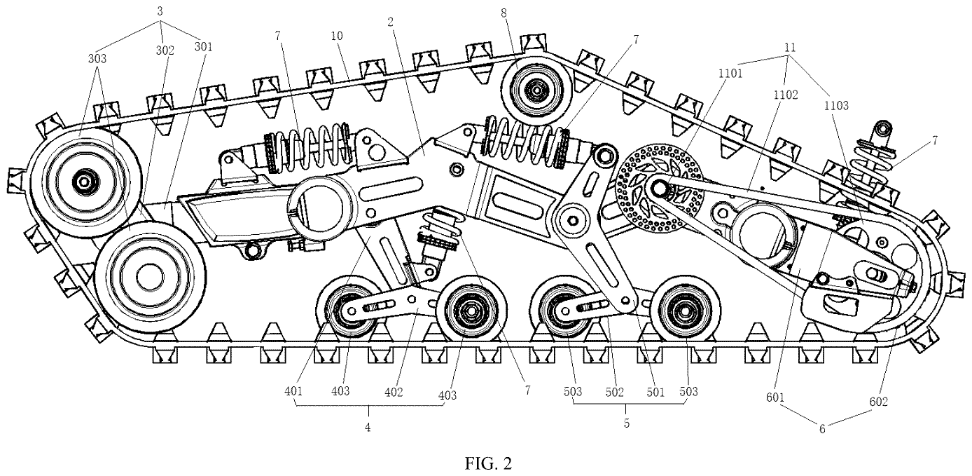

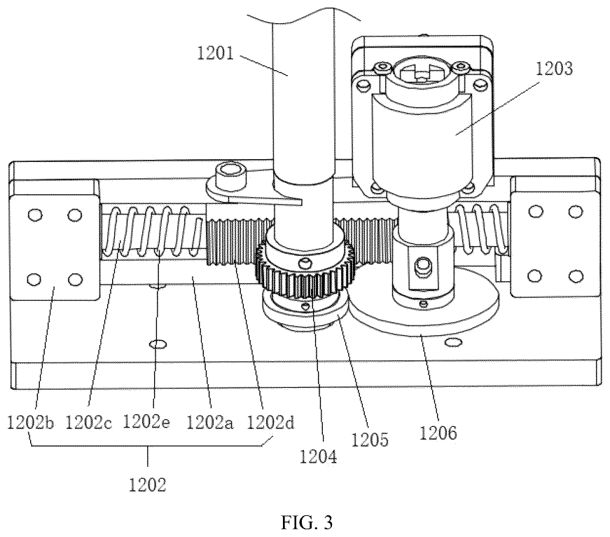

As shown in FIGS. 1 to 3, a dual-track all-terrain vehicle includes vehicle body 1. Two sides of the vehicle body 1 each are provided with a zigzag mounting seat 2. Guide wheel mechanism 3, first Christie suspension mechanism 4, second Christie suspension mechanism 5, and driving wheel mechanism 6 are hinged on the mounting seat 2. Dampers 7 are arranged between the mounting seat 2 and each of the guide wheel mechanism 3, the first Christie suspension mechanism 4, and the second Christie suspension mechanism 5. Damper 7 is provided between the driving wheel mechanism 6 and the vehicle body 1. The mounting seat 2 is further provided with track tensioner 8 and motor 9. The guide wheel mechanism 3, the first Christie suspension mechanism 4, the second Christie suspension mechanism 5, the driving wheel mechanism 6, and the track tensioner 8 located at a same side of the vehicle body 1 are provided with track 10. A power output shaft of the motor 9 is connected to the driving wheel mechanism 6 through belt transmission pair 11 in a transmission manner.

The guide wheel mechanism 3 includes linear guide wheel swing arm 301, linear guide wheel mounting arm 302, and four guide wheels 303. A rear part of the guide wheel swing arm 301 is hinged on a front part of the mounting seat 2. Damper 7 is provided between a top part of the guide wheel swing arm 301 and the mounting seat 2. The guide wheel mounting arm 302 is fixed on a front part of the guide wheel swing arm 301. Two ends of the guide wheel mounting arm 302 each are provided with two guide wheels 303.

The first Christie suspension mechanism 4 includes linear first road wheel swing arm 401, “\hat{ }”-shaped first road wheel mounting arm 402, and three first road wheels 403. An upper part of the first road wheel swing arm 401 is hinged on the mounting seat 2. Damper 7 is provided between a middle part of the first road wheel swing arm 401 and the mounting seat 2. The first road wheel mounting arm 402 is fixedly provided at a bottom part of the first road wheel swing arm 401. A front part of the first road wheel mounting arm 402 is provided with one first road wheel 403, while a rear part of the first road wheel mounting arm 402 is provided with two first road wheels 403 that are coaxially arranged.

The second Christie suspension mechanism 5 includes “<”-shaped second road wheel swing arm 501, “\hat{ }”-shaped second road wheel mounting arm 502, and three second road wheels 503. A middle part of the second road wheel swing arm 501 is hinged on the mounting seat 2. Damper 7 is provided between a top part of the second road wheel swing arm 501 and the mounting seat 2. The second road wheel mounting arm 502 is fixedly provided at a bottom part of the second road wheel swing arm 501. A front part of the second road wheel mounting arm 502 is provided with one second road wheel 503, while a rear part of the second road wheel mounting arm is provided with two second road wheels 503 that are coaxially arranged.

The driving wheel mechanism 6 includes linear driving wheel mounting arm 601 and driving wheel 602. A front part of the driving wheel mounting arm 601 is hinged on a rear part of the mounting seat 2. The driving wheel 602 is rotatably provided at a rear part of the driving wheel mounting arm 601. The belt transmission pair 11 includes driving pulley 1101, transmission belt 1102, and driven pulley 1103. The driving pulley 1101 is provided on the power output shaft of the motor 9. The driven pulley 1103 is provided on the driving wheel 602. The transmission belt 1102 is tensioned by the driving pulley 1101 and the driven pulley 1103.

The first Christie suspension mechanism with three first road wheels cooperates with the second Christie suspension mechanism with three second road wheels to effectively share the weight of the all-terrain vehicle, such that each road wheel can evenly bear the load. The design reduces the wear of the road wheels, and improves the lateral stability of the all-terrain vehicle, thereby preventing the all-terrain vehicle from rolling or overturning during running.

The vehicle body 1 is provided with a vehicle control unit and two motor drivers. A front part of the vehicle body 1 is provided with linear steering control mechanism 12. A signal output terminal of the linear steering control mechanism 12 is connected to a signal input terminal of the vehicle control unit through a cable. A signal output terminal of the vehicle control unit is connected to signal receiving terminals of the two motor drivers through a cable. The two motor drivers are respectively connected to wiring terminals of the two motors 9 through a cable.

The linear steering control mechanism 12 includes freely rotatable steering shaft 1201, reaction force assembly 1202 for resetting the steering shaft, and linear sensor 1203 for monitoring a rotation angle of the steering shaft. The steering shaft 1201, the reaction force assembly 1202, and the linear sensor 1203 are located at the front part of the vehicle body 1. A top part of the steering shaft 1201 is provided with handlebar 1201a for controlling the rotation of the steering shaft. The reaction force assembly 1202 includes rectangular mounting plate 1202a, two clamping elements 1202b, guide shaft 1202c, rack 1202d, and two compression springs 1202e. The two clamping elements 1202b are respectively provided on front surfaces at two ends of the mounting plate 1202a. Two ends of the guide shaft 1202c are respectively clamped between the two clamping elements 1202b and the mounting plate 1202a. The guide shaft 1202c is sleeved with the rack 1202d and the two compression springs 1202e. The two compression springs 1202e are respectively clamped between the rack 1202d and the two clamping elements 1202b. A bottom part of the steering shaft 1201 is provided with transmission gear 1204 and first synchronous transmission wheel 1205. The transmission gear 1204 meshes with the rack 1202d. A sensing shaft of the linear sensor 1203 is provided with second synchronous transmission wheel 1206. The first synchronous transmission wheel 1205 is in rolling contact with the second synchronous transmission wheel 1206.

In this embodiment, the linear sensor 1203 is an angular displacement sensor.

The vehicle control unit is communicated with the two motor drivers through a controller area network (CAN) bus or other internal network protocol of the vehicle.

The first synchronous transmission wheel, the second synchronous transmission wheel, and the linear sensor cooperate to accurately acquire the rotation angle of the steering shaft rotated by the driver, and sequentially generate steering signals for the vehicle control unit. The vehicle control unit processes the steering signals and sends operation signals of the left and right motors to the two motor drivers respectively. The two motor drivers respectively drive the two motors to operate based on the received operation signals. In this way, the track wheels at the two sides of the vehicle body are driven to perform differential operation, achieving the steering of the dual-track all-terrain vehicle.

The linear sensor can accurately monitor the rotation angle of the steering shaft rotated by the driver, improving the steering control accuracy of the dual-track all-terrain vehicle. The driver operates the steering shaft to rotate, without being affected by changes in the resistance subjected by the track wheels, improving the steering stability of the dual-track all-terrain vehicle and facilitating the driver's operation.

In order to better control the operation of the two motors, the vehicle is further provided with an attitude sensor for monitoring an attitude of the vehicle body, an accelerator pedal, and a pedal sensor. A sensing head of the pedal sensor is connected to the accelerator pedal. A signal output terminal of the attitude sensor and a signal output terminal of the pedal sensor are connected to the signal input terminal of the vehicle control unit through a cable. On the basis of the steering signal, the vehicle control unit comprehensively processes an attitude signal of the vehicle body sent by the attitude sensor and an acceleration signal sent by the pedal sensor, and sends the operation signals of the two motors to the two motor drivers respectively.

A steering wheel and a turning radius of the dual-track all-terrain vehicle when the dual-track all-terrain vehicle turns are designed according to the following working principle.

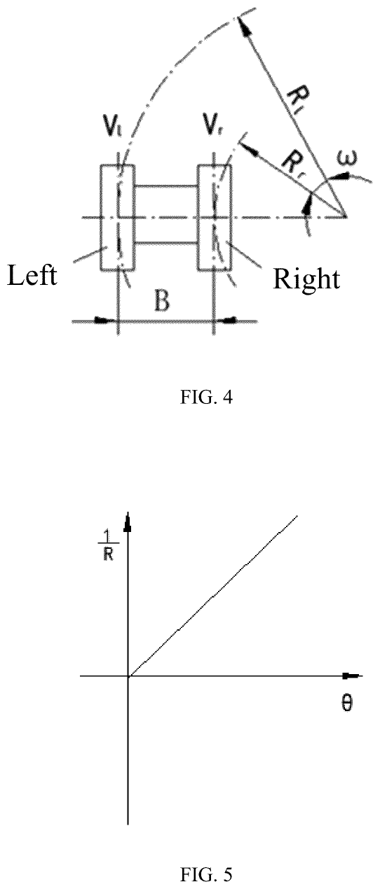

As shown in FIG. 4, when the dual-track all-terrain vehicle turns right, a left track travels at a speed of V₁ and a turning radius of Rₗ, while a right track travels at a speed of Vᵣ and a turning radius of Rᵣ. An angular speed at which the dual-track all-terrain vehicle turns is ω, and a center distance between the left track and the right track of the vehicle is B. According to a speed calculation equation, the following equations are derived:

$${V}_{l} = {R}_{l} \cdot ω = ( {R}_{r} + B ) \cdot ω \qquad ( Eq . 1 )$$

$${V}_{r} = {R}_{r} \cdot ω \qquad ( Eq . 2 )$$

A speed difference between the travel speed of the left track and the travel speed of the right track is derived from Eqs. 1 and 2 as follows:

$${V}_{l} - {V}_{r} = ( {R}_{r} + B ) \cdot ω - {R}_{r} \cdot ω = B \cdot ω \qquad ( Eq . 3 )$$

The relationship between angular speed and speed difference can be derived from Eq. 3 as follows:

$$ω = \frac{{V}_{l} - {V}_{r}}{B} \qquad ( Eq . 4 )$$

A relationship between the travel speed of the left track and the angular speed is derived from Eqs. 1 and 3 as follows:

$${R}_{l} = \frac{{V}_{l}}{ω} = \frac{{V}_{l}}{{V}_{l} - {V}_{r}} \cdot B \qquad ( Eq . 5 )$$

From Eq. 5, it can be seen that the turning radius of the left track is inversely proportional to the angular speed. When the angular speed increases, the turning radius decreases; and when the angular speed decreases, the turning radius increases.

The rotation angle of the steering shaft is θ. The rotation angle of the steering wheel affects the degree of steering the vehicle.

From FIG. 5, it can be seen that the relationship between the rotation angle θ of the steering shaft and the turning radius is that a larger rotation angle leads to a smaller turning radius, and on the contrary, a smaller rotation angle leads to a larger turning radius.

Overall, in practical applications:
In a low-speed turning situation, when the dual-track all-terrain vehicle is running at low speeds, the rotation angle of the steering shaft is large and the turning radius is small, making it easy for the vehicle to turn.
In a high-speed turning situation, when the dual-track all-terrain vehicle is running at high speeds, the rotation angle of the steering shaft is small and the turning radius is large, ensuring vehicle stability and safety.

The above described are the basic principles, main features, and advantages of the present disclosure. It should be understood by those skilled in the art that, the present disclosure is not limited by the above embodiments, and the above embodiments and the descriptions only illustrate the principle of the present disclosure. Various changes and modifications may be made to the present disclosure without departing from the spirit and scope of the present disclosure, and such changes and modifications all fall within the claimed scope of the present disclosure.

What is claimed is:

1. A dual-track all-terrain vehicle, comprising a vehicle body, wherein two sides of the vehicle body each are provided with a zigzag mounting seat;
a guide wheel mechanism, a first Christie suspension mechanism, a second Christie suspension mechanism, and a driving wheel mechanism are hinged on the zigzag mounting seat;
dampers are arranged between the zigzag mounting seat and each of the guide wheel mechanism, the first Christie suspension mechanism, and the second Christie suspension mechanism;
a damper is provided between the driving wheel mechanism and the vehicle body;
the zigzag mounting seat is further provided with a track tensioner and a motor;
the guide wheel mechanism, the first Christie suspension mechanism, the second Christie suspension mechanism, the driving wheel mechanism, and the track tensioner located at a same side of the vehicle body are provided with a track;
a power output shaft of the motor is connected to the driving wheel mechanism through a belt transmission pair in a transmission manner;
the vehicle body is provided with a vehicle control unit and two motor drivers;
a front part of the vehicle body is provided with a linear steering control mechanism;
a signal output terminal of the linear steering control mechanism is connected to a signal input terminal of the vehicle control unit through a first cable;
a signal output terminal of the vehicle control unit is connected to signal receiving terminals of the two motor drivers through a second cable; and
the two motor drivers are respectively connected to wiring terminals of the two motors through a third cable.

2. The dual-track all-terrain vehicle according to claim 1, wherein the linear steering control mechanism comprises a freely rotatable steering shaft, a reaction force assembly for resetting the freely rotatable steering shaft, and a linear sensor for monitoring a rotation angle of the freely rotatable steering shaft;
the freely rotatable steering shaft, the reaction force assembly, and the linear sensor are located at the front part of the vehicle body;
the reaction force assembly comprises a rectangular mounting plate, two clamping elements, a guide shaft, a rack, and two compression springs;
the two clamping elements are respectively provided on front surfaces at two ends of the rectangular mounting plate;
two ends of the guide shaft are respectively clamped between the two clamping elements and the rectangular mounting plate;
the guide shaft is sleeved with the rack and the two compression springs;
the two compression springs are respectively clamped between the rack and the two clamping elements;
a bottom part of the freely rotatable steering shaft is provided with a transmission gear and a first synchronous transmission wheel;
the transmission gear meshes with the rack;
a sensing shaft of the linear sensor is provided with a second synchronous transmission wheel; and
the first synchronous transmission wheel is in rolling contact with the second synchronous transmission wheel.

3. The dual-track all-terrain vehicle according to claim 2, wherein the linear sensor is an angular displacement sensor.

4. The dual-track all-terrain vehicle according to claim 2, wherein a top part of the freely rotatable steering shaft is provided with a handlebar for controlling rotation of the freely rotatable steering shaft.

5. The dual-track all-terrain vehicle according to claim 1, wherein the guide wheel mechanism comprises a linear guide wheel swing arm, a linear guide wheel mounting arm, and four guide wheels; a rear part of the linear guide wheel swing arm is hinged on a front part of the zigzag mounting seat; a damper is provided between a top part of the linear guide wheel swing arm and the zigzag mounting seat; the linear guide wheel mounting arm is fixed on a front part of the linear guide wheel swing arm; and two ends of the linear guide wheel mounting arm each are provided with two guide wheels.

6. The dual-track all-terrain vehicle according to claim 1, wherein the first Christie suspension mechanism comprises a linear first road wheel swing arm, a “\hat{ }”-shaped first road wheel mounting arm, and three first road wheels; an upper part of the linear first road wheel swing arm is hinged on the zigzag mounting seat; a damper is provided between a middle part of the linear first road wheel swing arm and the zigzag mounting seat; the “\hat{ }”-shaped first road wheel mounting arm is fixedly provided at a bottom part of the linear first road wheel swing arm; and a front part of the “\hat{ }”-shaped first road wheel mounting arm is provided with one first road wheel, while a rear part of the “\hat{ }”-shaped first road wheel mounting arm is provided with two first road wheels that are coaxially arranged.

7. The dual-track all-terrain vehicle according to claim 1, wherein the second Christie suspension mechanism comprises a “<”-shaped second road wheel swing arm, a “\hat{ }”-shaped second road wheel mounting arm, and three second road wheels; a middle part of the “<”-shaped second road wheel swing arm is hinged on the zigzag mounting seat; a damper is provided between a top part of the “<”-shaped second road wheel swing arm and the zigzag mounting seat; the “\hat{ }”-shaped second road wheel mounting arm is fixedly provided at a bottom part of the “<”-shaped second road wheel swing arm; and a front part of the “\hat{ }”-shaped second road wheel mounting arm is provided with one second road wheel, while a rear part of the “\hat{ }”-shaped second road wheel mounting arm is provided with two second road wheels that are coaxially arranged.

8. The dual-track all-terrain vehicle according to claim 1, wherein the driving wheel mechanism comprises a linear driving wheel mounting arm and a driving wheel; a front part of the linear driving wheel mounting arm is hinged on a rear part of the zigzag mounting seat; the driving wheel is rotatably provided at a rear part of the linear driving wheel mounting arm; the belt transmission pair comprises a driving pulley, a transmission belt, and a driven pulley; the driving pulley is provided on the power output shaft of the motor; the driven pulley is provided on the driving wheel; and the transmission belt is tensioned by the driving pulley and the driven pulley.
